(19) United States
(12) Patent Application Publication
(10) Pub. No.: US 2006/0273191 A1
(43) Pub. Date: Dec. 7, 2006

(54) Flexible riser for irrigation means

(76) Inventor: Darrell Pastuch, Tequesta, FL (US)

Correspondence Address: MCHALE & SLAVIN, P.A., 2855 PGA BLVD, PALM BEACH GARDENS, FL, 33410, US

(21) Appl. No.: 11/145,263

(22) Filed: Jun. 2, 2005

(51) Int. Cl. B05B 15/06

(52) U.S. Cl. 239/201; 239/588

(57) ABSTRACT

The present invention provides a flexible riser useful for supporting irrigation fixtures at one end at a desired height above the ground and the other end connected to a water supply line. The flexible riser includes a tubular inner sheath member and a spring means. According to a preferred form of the invention, the sheath member is disposed within the spring means and the length of the sheath member is longer than said length dimension of said spring means for the purpose of preventing the riser from breaking when bent in any direction by an external force.

### FIELD OF THE INVENTION

This invention relates to an article of manufacture useful in the irrigation field. More particularly, it relates to a flexible supporting member upon which sprinkler heads and other irrigation accessories may be mounted.

### BACKGROUND OF THE INVENTION

Irrigations systems comprise a series of underground conduit (i.e. pipes, hose, etc) connected to a fluid source, such that fluid flows from the source through the network of conduit to the ground by way of at least one irrigation fixture. The irrigation fixture is perpendicularly attached to the subterranean network by means of a riser positioned at desired locations along the network. These fixtures can be in sliding attachment to the riser and protrude vertically from the upper portion of the riser only upon activation of water pressure, or else, remain fixed to the upper portion of the riser.

The riser generally comprises a hollow cylindrical conduit, wherein the lower portion of the conduit includes a means to engage a conduit joint, for example, pipe tee joint. The conduit joint is attached at least at one end to the fluid supply line. Various types of irrigation fixtures, or accessories, can be attached to the upper portion of the riser, for example, sprinklers, drip nozzles and the like.

The hollow cylindrical conduit of the riser serves the dual purpose of supplying the fluid to, and providing support for, the irrigation fixture. It is the upward protruding riser that often receives most of the force when something collides with it. If hit with sufficient force, the riser often breaks at the joint where it is attached to the water supply line. In the case of such mishaps, repair of the fixture requires extensive work, including digging up the surrounding fluid supply piping, cutting out and replacement of the joint, riser and/or fixture. Thus, if there were a means available for absorbing the physical shock of an impact on such a riser by lawn equipment, an automobile, or other source of force without permitting breakage of the conduit at its base, it would alleviate the need for such repairs.

### SUMMARY OF THE INVENTION

The present invention provides a flexible device useful for supporting irrigation fixtures at the desired height above the ground. The riser includes a spring means with a first end portion, a second end portion and a length dimension; and an inner sheath member having a first end portion, a second end portion, and a length dimension. According to a preferred form of the invention, the sheath member is disposed within the spring means and the length of the sheath member is longer than said length dimension of said spring means.

Accordingly, it is the principle objective of this invention to provide a flexible riser that is connected at one end to a fluid inlet line and the other end to a irrigation fixture, which is able to withstand impacts or collisions resulting from contact with equipment or people without damaging the riser, fluid inlet connection and/or fixture.

It is a further objective of the present invention to provide a flexible riser that can be installed in any existing irrigation system.

Yet a further objective of the present invention is to provide a flexible riser that is constructed from non-corrosive materials so as not to deteriorate.

Another objective of the instant invention is to provide a flexible riser that will prevent breaking when bent in any direction by an external force.

Other objectives and advantages of the present invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of a riser according to a first embodiment of the present invention;

FIG. 2 is a cross-section view of the riser depicted in FIG. 1;

FIG. 3 is a perspective view of a riser according to a second embodiment of the present invention;

FIG. 4 is a cross-section view of the riser depicted in FIG. 3;

FIG. 5 is an exploded view of a riser according to the second embodiment of invention as shown in FIGS. 3 and 4;

FIG. 6 is a perspective view that demonstrates the flexibility of the riser according to the second embodiment of the present invention;

FIG. 7 is an exploded view illustrating the water inlet conduit in a subterranean location to be connected to the flexible riser of the present invention and additional riser attached to the irrigation fixture;

FIG. 8 is a perspective view illustrating the water inlet conduit in a subterranean location connected to the flexible riser of the present invention attached to an additional riser and irrigation fixture.

### DETAILED DESCRIPTION OF THE PREFERRED EMBODIMENTS

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representative basis for teaching one skilled in the art to variously employ the present invention in virtually any appropriately detailed structure.

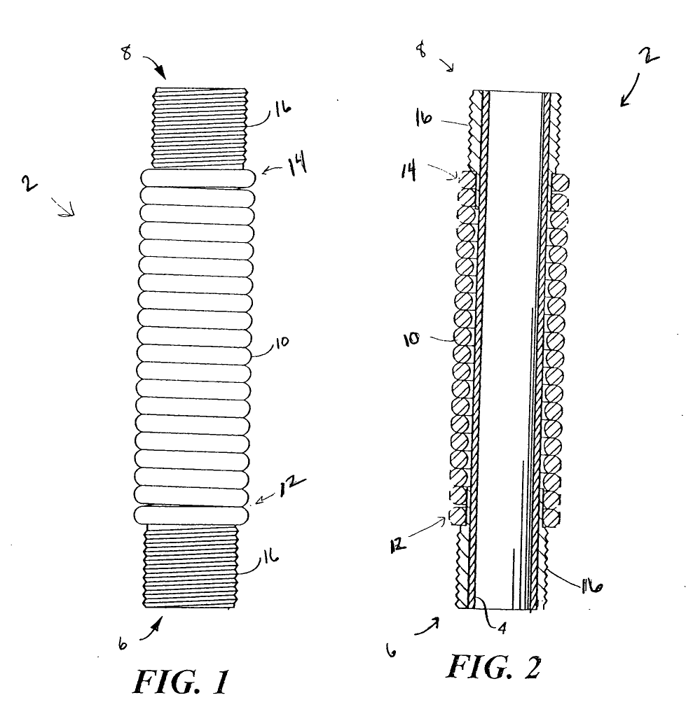

Referring now to FIGS. 1-8, wherein like elements are numbered consistently throughout, FIGS. 1 and 2 shows a flexible riser according to one embodiment of the invention, generally referred to as 2. The flexible riser 2 of the invention generally comprises a flexible, tubular sheath member 4 (FIG. 2), with a first end portion 6 and a second end portion 8, disposed within a flexible spring means 10 with a first end portion 12 and second end portion 14. The sheath member 4 is disposed within the hollow cylindrical space defined by the helical coil construction of the flexible spring means 10, such that the axis of the sheath member 4 substantially coincides with the axis of the of the spring means 10.

The invention contemplates situations wherein the outer diameter of the sheath member 4 is less than the inner diameter of the spring means 10 between about 0.10 inches to about 10.00 inches, including every 0.01 inches therebetween.

The sheath member 4 is a continuous, flexible tubular member, preferably made from a flexible thermoplastic material (i.e. polyvinylchloride) or polymeric materials (i.e. polyurethanes, polypropylene) or other organic polymers known in the art. However, other materials could be used for the fabrication of the sheath member 4 inasmuch as they are known to those skilled in the art as being capable of flexing and transporting fluid therein without leaking, corroding or otherwise deteriorating.

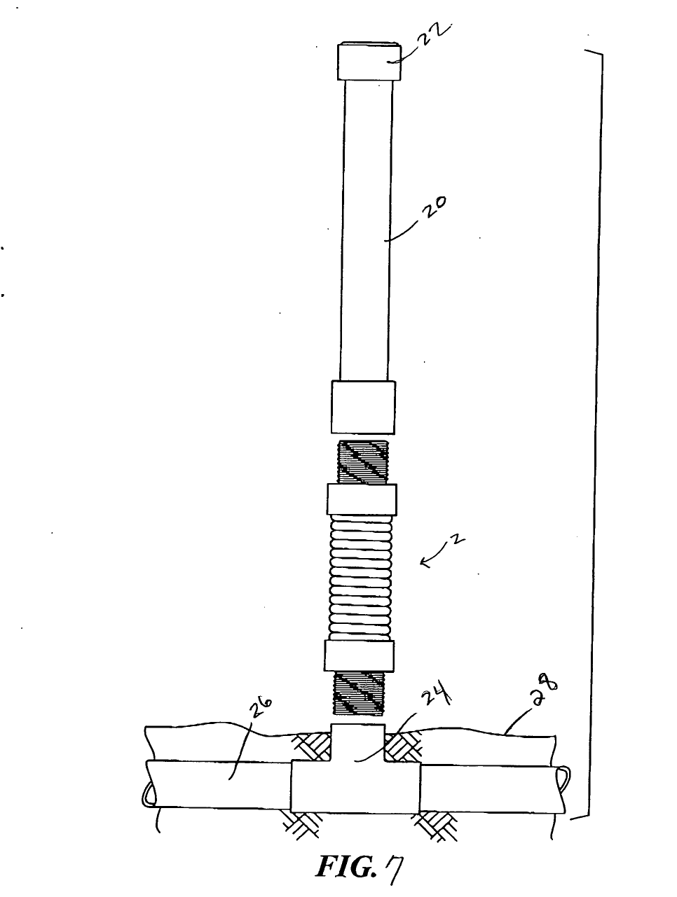

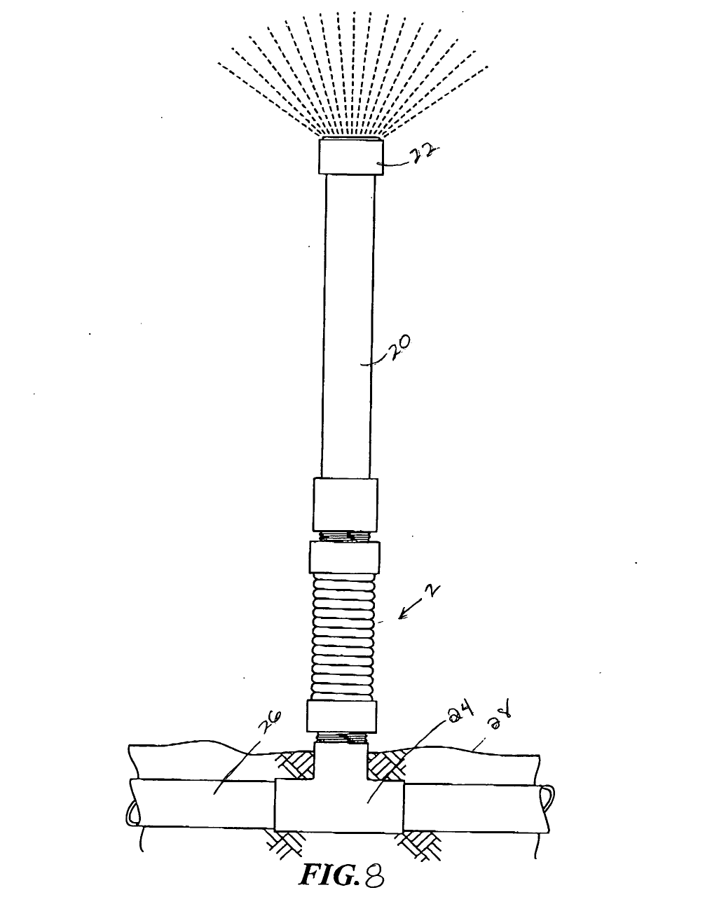

According to one embodiment of the present invention shown in FIGS. 1-2, the first and second end portions 6, 8 of the sheath member 4 are integrally formed with an attachment means 16, shown here as male threads, used to connect to a fluid supply line 26 and an irrigation fixture 22, respectively (FIGS. 7-8). The attachment means 16 and sheath member 4 may be of the same construct. For example, the sheath member 4 and end portions 6,8 may be integrally formed through the process of injection molding from a suitable flexible thermoplastic or polymeric material.

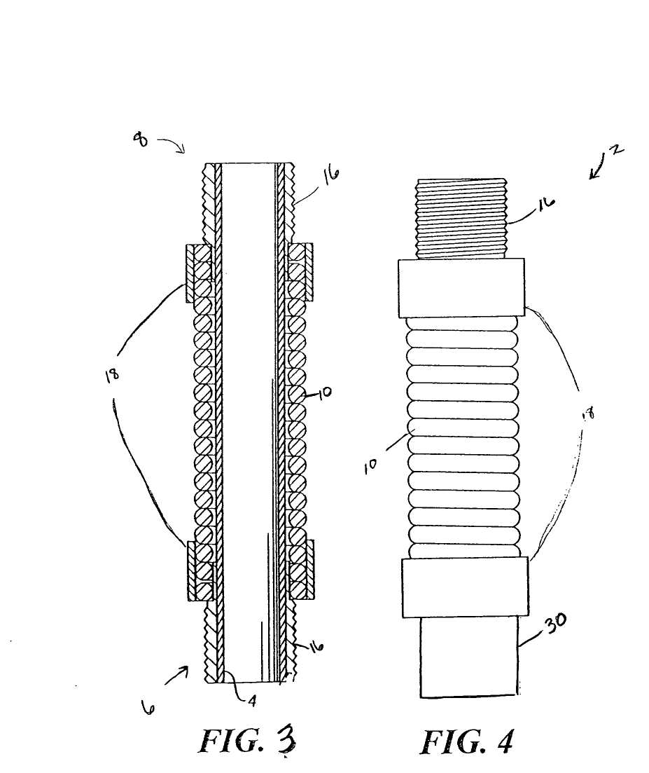

In an alternate embodiment depicted in FIGS. 3-6, the attachment means 16, also shown as male threads, are separately formed and secured to the both the spring means 10 and sheath member end portions 6,8 by at least one coupling means 18 that surrounds the outer diameter of the spring means 10. Such a provision rigidly affixes the spring means 10, attachment means 16, and sheath member 4 together and provides added strength to the construction as a whole. It is noted that the coupling means 18 could be any means known in the art to rigidly affix the spring means 10, attachment means 16 and sheath member 4 simultaneously, for example, albeit not limited to welding, adhesives, pins, screws, rivets, or fasteners or the like.

Alternatively, the attachment means 16 could be secured exclusively to the first and second ends 6,8 of the sheath member 4 using any conventional means to affix known to those skilled in the art, (i.e. welding, adhesives, pins, screws, rivets, or fasteners). In addition, the attachment means 16 could be fabricated from a different material than the sheath member 4, such as metal or metal alloy (i.e. iron, steel and the like) or polymeric material known in the art.

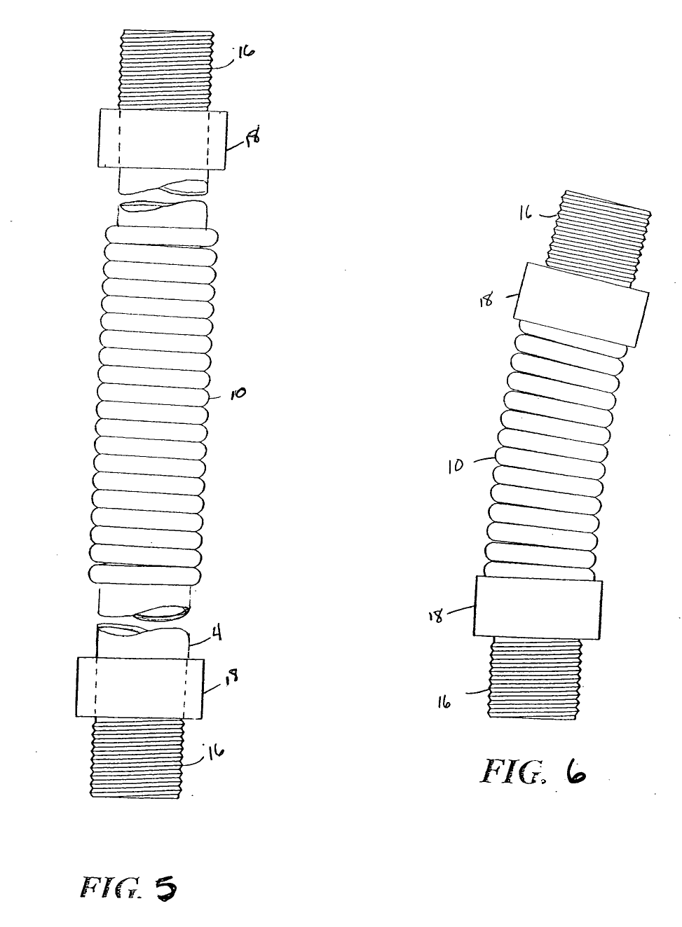

The attachment means 16 shown in FIGS. 1-4 are illustrated as male threads, however, it is noted that these could be readily replaced with female threads, that is, the threads are formed on the interior surface of the tubular sheath member at the first and second ends 6, 8. The use of male or female threads enables a fluid tight engagement with corresponding threads typically found in commercially available conduit joints and irrigation fixtures, see FIGS. 7-8. Moreover, the invention contemplates one of the sheath member end portions 6,8 having female threads and the remaining end portion 6, 8 comprising male threads. As known in the art, such fluid-tight attachment between threaded fittings can be advanced by plumber's tape, putty or the like (not shown). As illustrated in FIG. 4, at least one of the first end or second end portions 6,8, could have a smooth surface 30 such that it is secured to the irrigation fixture 22, or fluid supply line 26, by any means known to those skilled in the art, i.e. adhesives, welding, rivets, or the like.

Generally, the spring means 10 is flexible and constructed of sufficient gauge so as to provide both structural rigidity and satisfactory flexing to an irrigation fixture 22 or other appendage affixed to the second end portion 8. In the preferred embodiment, the spring means 10 can be fabricated from any metal or metal alloy (i.e. iron, steel and the like).

Once the sheath member 4 is disposed within the tubular cavity of the spring means 10, and the first and second ends 6,8 of the sheath member 4 are attached to the fluid supply line 26 and irrigation fixture 22, respectively, the water source may then be enabled. Such an arrangement allows the vertically protruding flexible riser 2 to flex or bend as shown in FIG. 6, instead of break at its base, when external pressure is applied in any direction by virtue of the spring means 10.

Further, there may be an additional riser 20 disposed between the irrigation fixture 22 and the second end portion 8, as shown in FIGS. 7-8. This additional riser 20 can be one removed by the user from an already existing irrigation system or an additional riser 20 that is secured to either end portion 6, 8 of the sheath member 4 and used to elevate the irrigation fixture 22 to a desired height above the ground 28. FIGS. 7-8 illustrate the additional riser 20 atop the flexible riser 2 of the present invention. Alternatively, the additional riser can be another flexible riser of the present invention. This configuration allows for proper watering, as it is important to keep the irrigation fixture 22 at a proper level with respect to the ground level 28, even after the irrigation fixture 22 is installed. For example, the ground level 28 may rise as mulch, new soil, or tall plants may be added to the area surrounding the irrigation fixture 22.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A flexible riser useful for supporting irrigation fixtures comprising:
a spring means comprising a coil of wire, wherein said spring means has a first end portion, a second end portion and a length dimension;
a tubular inner sheath member having a first end portion, a second end portion, a length dimension, said first end portion of said inner sheath member in fluid communication with a fluid supply line;
wherein the outer diameter of said sheath member is smaller than the inner diameter of the spring means, and wherein said sheath member is disposed within said spring means, said length dimension of said flexible inner sheath member being longer than said length dimension of said spring means.

2. The flexible according to claim 1 further comprising an irrigation fixture disposed at said second end portion of said inner sheath member.

3. The flexible riser according to claim 2 wherein said irrigation fixture is a sprinkler head, drip nozzle or other irrigation fixture known in the art.

4. The flexible riser according to claim 1 wherein at least one of said first end portion or said second end portion of said sheath member includes threads.

5. The flexible riser according to claim 4 wherein said threads are selected from the group consisting of male threads or female threads.

6. The flexible riser according to claim 1 wherein both of said first end portion and said second end portion of said sheath member comprise an attachment means.

7. The flexible riser according to claim 6 wherein said attachment means comprise threads selected from male threads or female threads.

8. The flexible riser according to claim 6 wherein said attachment means is smooth.

9. The flexible riser according to claim 7 wherein said attachment means are comprised of a metal or metal alloy.

10. The flexible riser according to claim 7 wherein said attachment means are made from a polymeric or thermoplastic material.

11. The flexible riser according to claim 1 wherein said spring means is rigidly affixed to at least one of said first end portion or said second end portion of said sheath member.

12. The flexible riser according to claim 11 further comprising an irrigation fixture disposed at said second end portion of said inner sheath member.

13. The flexible riser according to claim 1 wherein said spring means is rigidly affixed to both of said first end portion and said second end portion of said sheath member.

14. The flexible riser according to claim 13 further comprising an irrigation fixture disposed at said second end portion of said inner sheath member.

15. The flexible riser according to claim 1 wherein said spring means is a metal or metal alloy.
